(19) United States
(12) Patent Application Publication
(10) Pub. No.: US 2011/0192136 A1
(43) Pub. Date: Aug. 11, 2011

(54) SOLID-PROPELLANT MOTOR

(75) Inventors: PETER GERD FISCH, UBERLINGEN (DE); GERD ELSNER, OBERUHLDINGEN (DE)

(73) Assignee: DIEHL BGT DEFENCE GMBH & CO. KG, UBERLINGEN (DE)

(21) Appl. No.: 13/006,896

(22) Filed: Jan. 14, 2011

Related U.S. Application Data
(63) Continuation of application No. PCT/EP2009/004917, filed on Jul. 8, 2009.

(30) Foreign Application Priority Data
Jul. 16, 2008 (DE) 10 2008 033 429.4

(51) Int. Cl. F02K 9/34

(52) U.S. Cl. 60/253

(57) ABSTRACT

A solid-propellant motor includes an outer casing and a combustion chamber which is disposed within the outer casing. In order to simplify the attachment of fittings, the combustion chamber is in the form of a separate component, which is separate from the outer casing.

### CROSS-REFERENCE TO RELATED APPLICATION

This is a continuation, under 35 U.S.C. §120, of copending International Application No. PCT/EP2009/004917, filed Jul. 8, 2009, which designated the United States; this application also claims the priority, under 35 U.S.C. §119, of German Patent Application DE 10 2008 033 429.4, filed Jul. 16, 2008; the prior applications are herewith incorporated by reference in their entirety.

### BACKGROUND OF THE INVENTION

### Field of the Invention

The invention relates to a solid-propellant motor having an outer casing and a combustion chamber which is disposed within the outer casing.

When constructing solid-propellant motors, it must be remembered that they have to absorb and withstand the inertia forces and drive forces as well as the resultant bending forces, which occur during operation, and some of which are referred to as inertia loads. In practice, therefore, solid-propellant motors are frequently manufactured from a metal tube, with the tube wall being used as the outer casing and the tube interior representing the combustion chamber. The metal tube, which is often manufactured integrally, therefore at the same time provides the outer casing and the combustion chamber, as well.

In order to reduce the weight and the physical volume of the solid-propellant motor, metal tubes with walls which are as thin as possible are used. Furthermore, motors have recently been manufactured from fiber composite structures, instead of from metal. If the forces described above can be absorbed by a homogeneous metal tube in the case of the metals, which are generally isotropic, a correspondingly directed fiber layer must be provided for each force component in a fiber composite structure. Therefore, while the metal tube wall is able to absorb the inertia and drive forces mentioned above, as well as the bending forces which result from them and the pressure forces from the combustion chamber, in one uniform layer, in the case of a fiber composite structure, different layers with a different fiber orientation must interact in order to ensure that absorption. Therefore, until now, different layers with a different fiber orientation have been combined by using a matrix to form a tube composed of fiber composite structures, which can be used instead of the described heavier metal tube.

FIG. 1 shows a diagrammatic, perspective illustration of a solid-propellant motor 1 according to the prior art, in which an outer casing 3 is formed by an integral metal tube or an integral fiber composite tube of the type described above. Such motors are generally used for propulsion or even as a support and for propulsion for objects. As rockets, for example, they are fitted with warheads or surveillance devices. In any case, the motors are intended to be connected to those objects or to further components, in particular wings. For that purpose, fittings or the further components must themselves be attached to the engine. By way of example, FIG. 1 shows such fittings 5 and 6 which, in the illustrated case, are intended to hold wings. As an example of a further fitting, a holding lug 4 is illustrated, which is used to attach the motor to a transport device, for example to an aircraft or helicopter.

Since the inner wall of the outer casing 3 is used as the combustion chamber at the same time, pressure is applied to it during operation. The attachment of fittings, in particular of the fittings 4, 5, 6 or attachments, is therefore generally difficult. For example, screw connections cannot be made directly to the outer casing 3 since the fitting of screws or the incorporation of drilled holes in the outer casing adversely affect its resistance to pressure. Furthermore, leaks can occur in the combustion chamber, thus adversely affecting its tamping effect, and therefore the acceleration effect of the motor. Furthermore, in order to ensure that the outer casing has walls which are as thin as possible, it is necessary when using solid ways of introducing forces, for example such as those for wings, to ensure that the outer casing can withstand increased loads, for which purpose measures to increase the robustness must be taken. As shown in the example in FIG. 1, these may include, inter alia, the provision of thickened areas 7. Since these thickened areas or the like in turn cannot be attached directly to the casing, their fitting is complex. This is even more true since the transitions to the thickened areas must be optimized for smooth stiffness transitions.

### SUMMARY OF THE INVENTION

It is accordingly an object of the invention to provide a solid-propellant motor, which overcomes the hereinafore-mentioned disadvantages of the heretofore-known devices of this general type and in which attachments can be attached more easily to an outer casing.

With the foregoing and other objects in view there is provided, in accordance with the invention, a solid-propellant motor, comprising an outer casing and a combustion chamber disposed within the outer casing. The combustion chamber is a separate component, which is separate from the outer casing.

This allows attachments, in particular fittings, to be attached to the outer casing without any adverse effect on the capability of the combustion chamber to absorb pressure. Corresponding assembly tasks can be carried out without adversely affecting the combustion chamber characteristics during the process.

In this case, an outer casing means an outer envelope of the solid-propellant motor, which does not necessarily have a closed surface. For example, the outer casing may be formed by the wall of a tube with open end faces. Furthermore, a combustion chamber refers to a cavity which is not closed and in which a solid propellant can be disposed, and which is suitable for tamping the solid propellant adequately while it is burning away, as a result of which material emerging from the combustion chamber can be converted to a propulsion effect.

Like the combustion chamber, the outer casing can also be manufactured both in a conventional manner from metals or metal alloys, or else from fiber composite structures.

In accordance with another feature of the invention, the outer casing is constructed to absorb inertia forces and inertia moments which occur during operation of the motor. The combustion chamber is also constructed to absorb pressures which occur during operation in the combustion chamber. The requirement for the individual component, that is to say the outer casing or the combustion chamber, is less stringent in this case, thus providing more freedom for the construction and implementation of the respective component. Each component can therefore be optimized more easily in its own right, in particular in terms of the material being used. This has been found to be particularly advantageous when both the outer casing and the combustion chamber are manufactured from fiber composite materials. In this case, fiber orientations and the number of fibers for manufacture of the outer casing are chosen in such a way that the inertia forces and inertia moments which occur during operation of the motor, as well as the resultant bending forces, can be absorbed. In contrast, the number and orientation of the fibers for the combustion chamber are constructed for the pressure forces which have to be absorbed. Outer casings according to the prior art, which at the same time represent the combustion chamber (see above), overall had to absorb the same forces as the outer casing and combustion chamber provided as separate components in the present invention. The difference is basically that the fiber layers in the present invention are separated on the basis of their function, and are contained either in the outer casing or in the combustion chamber. In consequence, the use of fiber composite materials for the invention has no relevant weight disadvantage in comparison to known solid-propellant motors. Furthermore, the motor is less sensitive to external influences, in particular mechanical influences, since the sensitive combustion chamber, which is constructed to absorb the pressure forces, is protected on the outside by the outer casing.

In accordance with a further feature of the invention, the combustion chamber is disposed at a distance from the outer casing. The cavity formed in this way between the outer casing and the combustion chamber on one hand reduces the heat transmitted to the combustion chamber from the outer casing, which is subjected to aerokinetic heating. On the other hand, components which until now have been attached to an outer envelope or casing surface of the outer casing can be advantageously aerodynamically disposed between the combustion chamber and the outer casing. In addition to the improvement in the aerodynamics of the motor, this makes it possible to provide additional protection for these components against external influences. For example, cables, entire cable harnesses, data transmitting devices, data receiving devices, antennas or plug connectors can be disposed between the combustion chamber and the outer casing. Furthermore, thickened areas or components provided with robustness in some other way are disposed between the outer casing and the combustion chamber, as a result of which they likewise do not have an adverse effect on the aerodynamic characteristics of the motor. Where a motor has internal flows, the components can be disposed between the outer casing and the combustion chamber in an advantageous manner with regard to internal flows.

In accordance with an added feature of the invention, the combustion chamber is held in at least one frame, which is disposed between the outer casing and the combustion chamber. This allows the combustion chamber to be mounted easily in the outer casing, at a distance from the outer casing. The inner wall of the outer casing can in this case advantageously be constructed to be very simple, specifically smooth, as a result of which no more increased manufacturing effort is required for the outer casing. In particular, no more thickened areas are required either on the outer wall or on the inner wall of the outer casing. In order to allow cables to be routed without any impediment in the area between the combustion chamber and the outer casing, the at least one frame preferably has cutouts for cables to pass through.

The at least one frame can advantageously be used as a measure to provide robustness instead of the outer thickened areas according to the prior art, as described with regard to FIG. 1. On one hand, this can be done with the inner wall of outer casing still being smooth (see above). On the other hand, the frame is disposed as a device to provide robustness within the outer casing, thus making it possible to achieve a greater bending strength for the same caliber as in the case of outer casings with robustness measures, for example thickened areas, disposed on the outer envelope or casing surface.

In accordance with an additional feature of the invention, the combustion chamber is held in a form-locking manner in the at least one frame. This allows the combustion chamber to be fitted quickly. A form-locking connection is one which connects two elements together due to the shape of the elements themselves, as opposed to a force-locking connection, which locks the elements together by force external to the elements.

In accordance with yet another feature of the invention, the combustion chamber is held with dimensional tolerances in the at least one frame. This takes into account the fact that motors have slight deformations over their length because of the largely minimized weight. In this case, the dimensional tolerances for holding it allow the combustion chamber to be fitted and removed more easily. Furthermore, repair and servicing tasks can be carried out more easily. If any movement of the combustion chamber which remains because of it being held with dimensional tolerances is undesirable, then this can be overcome by clamping the combustion chamber.

In accordance with yet a further feature of the invention, at least one frame is connected to a holding lug, which rests indirectly or directly on an outer envelope or casing surface of the outer casing. As explained above, such holding lugs are used in order to attach motors to aircraft or helicopters, for example. The connection of the holding lug to the frame which holds the combustion chamber allows the weight force which acts on a filled combustion chamber to be transmitted advantageously to the holding lug without first of all having to act on the outer casing.

In accordance with yet an added feature of the invention, the outer casing is clamped between the at least one frame and the holding lug which is connected to it. This allows the outer casing to be attached to the combustion chamber through the frame without any additional connecting device being required for this purpose. This makes it possible to speed up the assembly and disassembly of the motor.

In accordance with yet an additional feature of the invention, alternatively, the outer casing can be connected to the at least one frame, for example by a screw connection. This may be found to be advantageous, depending on the type of manufacture and the purpose of the motor.

In accordance with still another feature of the invention, the combustion chamber is secured through the use of at least one skirt against movement with respect to the outer casing. This ensures constant ballistics of the motor, apart from the solid propellant burning away.

In accordance with still a further feature of the invention, the outer casing is manufactured from a high-temperature-resistant material. A fiber composite material with a high-temperature matrix is preferably used in this case. The terms high-temperature-resistant material and high-temperature matrix in this case should be understood to mean that they are suitable for withstanding the aerokinetic heating which occurs during operation of the motor. This becomes even more important the faster the motor travels. The high-temperature resistance must therefore be taken into account in particular for high-speed airborne vehicles, such as rocket motors. As an alternative to the use of a high-temperature-resistant material for the outer casing, it is possible to cover the outer envelope or casing surface of the outer casing with a temperature protection layer, for example a ceramic layer. The temperature protection layer in this case should be constructed in such a way that a material which is used for the outer casing is not adversely affected by the temperature transferred from the temperature protection layer to the outer casing.

In accordance with still an added feature of the invention, thermal insulation is provided within the combustion chamber, for the thermal insulation from the combustion chamber of a solid propellant, which can be disposed in the combustion chamber. In addition to the thermal insulation which may be provided by the configuration of the combustion chamber at a distance from the outer casing, the thermal insulation which is disposed in the combustion chamber reduces the heat transfer from the outer casing through the combustion chamber to the solid propellant. This improves the safety of the motor against inadvertent ignition, for example in the event of a fire, since heating of the solid propellant to its ignition temperature is delayed. This safety improvement contributes to compliance with the so-called insensitive munitions requirements. In this case, the combustion chamber is preferably substantially completely clad with the thermal insulation. Only functional areas, such as an aperture opening for an igniter or a gas guide tube, are not provided with thermal insulation.

In accordance with still an additional feature of the invention, in order to comply with the insensitive munitions requirements and therefore to improve safety, the combustion chamber is manufactured from a material which is unstable above a limit temperature, wherein the limit temperature is chosen to be less than or equal to an ignition temperature of a solid propellant which can be disposed in the combustion chamber. In this way, the combustion chamber becomes unstable when heated before the ignition temperature of the solid propellant is reached and it is ignited. The increasing instability reduces the tamping effect of the combustion chamber, so that a pressure which builds up on reaching or exceeding the ignition temperature can escape through the combustion chamber. In consequence, the solid propellant can burn away without this resulting in an explosion. This safety mechanism also comes into effect when the temperature rises slowly and therefore contributes to compliance with the so-called slow cook-off requirements.

In accordance with again another feature of the invention, a further safety improvement is provided by overpressure openings in the outer casing, which represents one development of the invention. Since the tamping effect during operation of the motor is ensured by the combustion chamber, such overpressure openings in the outer casing can be provided according to the invention. For example, if an increased pressure inadvertently occurs in the motor as a result of a solid propellant being ignited, for example in the case of a fire, then this increased pressure can escape through the overpressure openings in the outer casing as soon as there is no longer any tamping effect on the combustion chamber. The tamping effect of the combustion chamber can be overcome, for example in the manner described above, by the use of an unstable material. This prevents a tamping effect caused by the outer casing leading to an inadvertent explosion of the motor in a situation such as that. The overpressure openings in this case are preferably formed by mounting openings which, for example, can be provided by openings for cables to pass through, or servicing openings.

In accordance with a concomitant feature of the invention, the combustion chamber is in the form of a modular component. This allows the combustion chamber to easily be replaced by a new one after the solid propellant has burned away or after the life/expiration date of the solid propellant disposed in the combustion chamber has elapsed. In principle, the rest of the motor can be reused unchanged. There is no need to wash out the outer casing, as is done in the case of conventional metal motors with an integral wall. The propellant charge, which includes the combustion chamber, thermal insulation and the solid propellant disposed therein, can therefore be replaced with less effort than in the case of motors according to the prior art. If a combustion chamber composed of metal is used, it is admittedly in principle possible to wash it out and to reuse it. However, that has been found to be more complex than complete replacement of the propellant charge. Furthermore, that would result in weight disadvantages. The modular construction furthermore makes it easier to manufacture the motor on a decentralized basis. The capability to replace the combustion chamber and/or the propellant charge easily also results in improved repair and servicing options.

The present invention has been described throughout in conjunction with solid propellants, and is referred to as a solid-propellant motor. In principle, however, the invention can also be used in conjunction with hybrid motors or gel motors.

Other features which are considered as characteristic for the invention are set forth in the appended claims.

Although the invention is illustrated and described herein as embodied in a solid-propellant motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a solid-propellant motor according to the prior art;

FIG. 2 is a side-elevational view of a first exemplary embodiment of a solid-propellant motor according to the invention;

FIG. 3 is a longitudinal-sectional view of the solid-propellant motor shown in FIG. 2;

FIG. 4 is an enlarged, fragmentary, longitudinal-sectional view of the left-hand portion of FIG. 3;

FIG. 5 is an enlarged, fragmentary, longitudinal-sectional view of the right-hand end portion of FIG. 3;

FIG. 6 is a perspective view of the section of FIG. 3;

FIG. 7 is an exploded-perspective view of the solid-propellant motor shown in FIG. 1;

FIG. 8 is an enlarged, fragmentary, exploded-perspective view of the left-hand end portion of FIG. 7;

FIG. 9 is an enlarged, fragmentary, exploded-perspective view of the right-hand end portion of FIG. 7; and

FIG. 10 is a fragmentary, longitudinal-sectional view of a second exemplary embodiment of a motor according to the invention.

### DETAILED DESCRIPTION OF THE INVENTION

Referring now in detail to the figures of the drawings, in which elements having the same effect are provided with the same reference symbols, and first, particularly, to FIG. 2 thereof, there is seen a diagrammatic, side-elevational view of a first exemplary embodiment of a solid-propellant motor 10 according to the invention. As can be seen from the illustration in FIG. 2, the solid-propellant motor 10 has an outer casing 13 with a left-hand end face to which a warhead 16 is connected. In the illustrated embodiment, three holding lugs 14a, 14b, 14c are disposed on an outer envelope or casing surface or lateral area 12 of the outer casing 13, through the use of which the solid-propellant motor 10 can, for example, be attached to a helicopter or an aircraft.

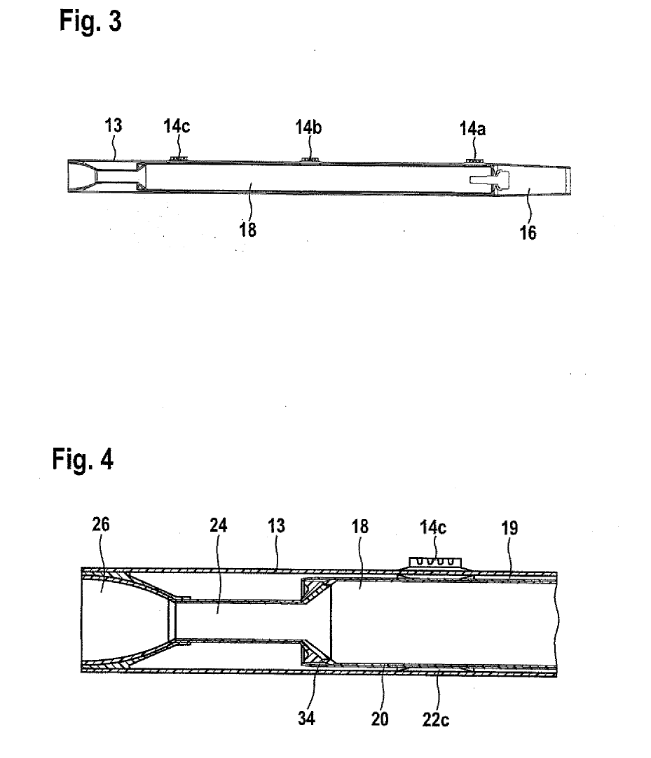

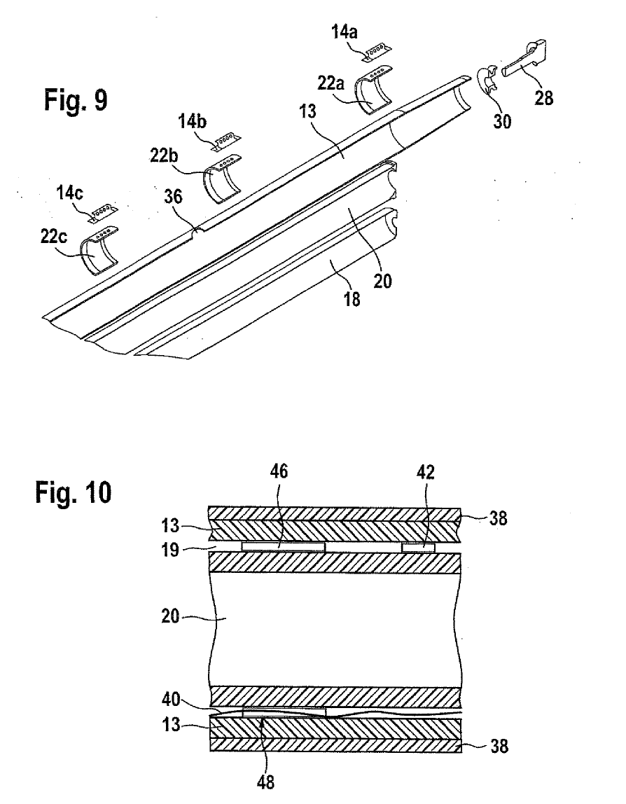

The diagrammatic illustration in FIG. 3, which is a section through the solid-propellant motor 10 of FIG. 2, shows further details. Compared with the illustration in FIG. 2, the solid-propellant motor has been rotated through 180° in this case, as a result of which the warhead 16 is shown at the right-hand edge of the illustration in FIG. 3. In addition to the holding lugs 14a, 14b, 14c, which are already seen in FIG. 2, and the outer casing 13, FIG. 3 illustrates insulation 18 which virtually completely clads a combustion chamber 20. This combustion chamber 20 can be seen more clearly in FIG. 4, which shows an enlarged left-hand end area of the illustration of FIG. 3, and in particular in an exploded illustration in FIG. 9.

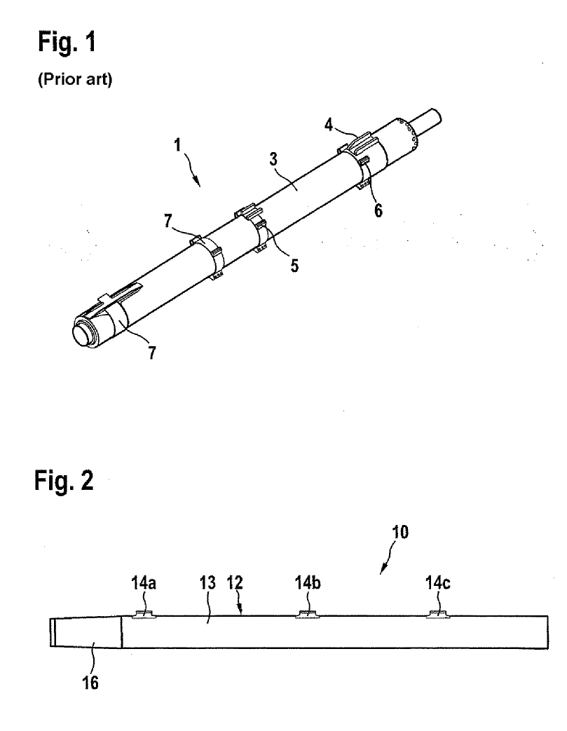

As can be seen in FIG. 4, in the illustrated exemplary embodiment, the combustion chamber 20 is disposed at a distance from the outer casing 13. A cavity 19, which is formed between the combustion chamber 20 and the outer casing 13, is used on one hand as insulation, thus reducing heat transfer to the combustion chamber 20 from the outer casing 13, which is heated aerokinetically during operation of the motor. This improves insensitive munitions characteristics of the motor in the manner described above. In addition, the cavity 19 offers space, in which to place cables or cable harnesses for controlling the motor, or data transmitting devices, data receiving devices, antennas or plug connectors between the combustion chamber and the outer casing. Those components are known per se, but are not illustrated in FIG. 4, for the sake of clarity. The configuration of all of these components, as far as possible, in the cavity 19 which is formed between the combustion chamber 20 and the outer casing 13, improves the aerodynamics of the motor 10, as is already evident from a comparison of the illustration in FIG. 2 with the prior art shown in FIG. 1. While the solid-propellant motor 1 in FIG. 1 has fittings 5 and 6 in addition to holding lugs 4, with the fittings 5 and 6 being furthermore disposed on the thickened areas 7 of the outer casing 3, the solid-propellant motor 10 according to the invention has an outer envelope or casing surface 12 of the outer casing 13 which is smooth apart from the holding lugs 14a, 14b and 14c. Although no fitting parts corresponding to the fittings 5 or 6 of FIG. 1 are provided in the illustration of FIG. 2, as are used for example for attachment of wings, these, or attachments in general, can, however, in principle be fitted at any desired point on the outer casing 13, because the outer casing 13 is separate from the combustion chamber 20, for example being attached by a connecting device. This is possible since this does not adversely affect the capability of the combustion chamber to withstand pressure loads, because of the physical separation of the combustion chamber 20 and the outer casing 13. Reinforced areas or reinforcing fittings corresponding to the thickened areas 7 shown in FIG. 1 can be disposed in the cavity 19 between the combustion chamber 20 and the outer casing 13 in the illustrated exemplary embodiment of the invention, in such a way that they are not externally visible and there is no negative effect on the aerodynamics of the motor 10.

In the exemplary embodiment shown in FIG. 4, the outer casing 13 is constructed to absorb the inertia forces and inertia moments which occur during operation of the motor, as well as the bending forces which result from them. In contrast, the combustion chamber 20 is constructed to absorb pressures which occur during operation in the combustion chamber 20. Due to this functional separation, the different components including the outer casing 13 and the combustion chamber 20 can be optimized to their tasks more easily and better. In the exemplary embodiment illustrated in FIGS. 2 to 9, the outer casing 13 is manufactured from a high-temperature-resistant fiber composite material. The high-temperature resistance in this case is ensured by the use of a high-temperature matrix, for example a cyanate ester. The combustion chamber 20 is likewise manufactured from a fiber composite material, but one which is unstable above an ignition temperature of a solid propellant which can be disposed in the combustion chamber 20. This improves the safety of the present solid-propellant motor against inadvertent ignition, and in particular this makes it possible to comply with slow cook-off requirements.

As can be seen from FIG. 4, the combustion chamber 20, which has been clad with the thermal insulation 18, opens at its left-hand end into a gas guide tube 24, which itself opens into an outlet nozzle 26. A control-surface machine for directional control of the motor, can be disposed in the space between the gas guide tube 24 and the outer casing 13 and is known per se, but is not illustrated in order to make the illustration clearer. Additionally or alternatively, further components can be disposed at this point, in particular those components for which there is no space in the cavity 19 which is formed between the combustion chamber 20 and the outer casing 13, because of the dimensions of the components. The gas guide tube 24 is attached to the combustion chamber 20 with the aid of a fitting ring 34. Any thrust forces which occur in the outlet nozzle 26 can be absorbed directly by its attachment.

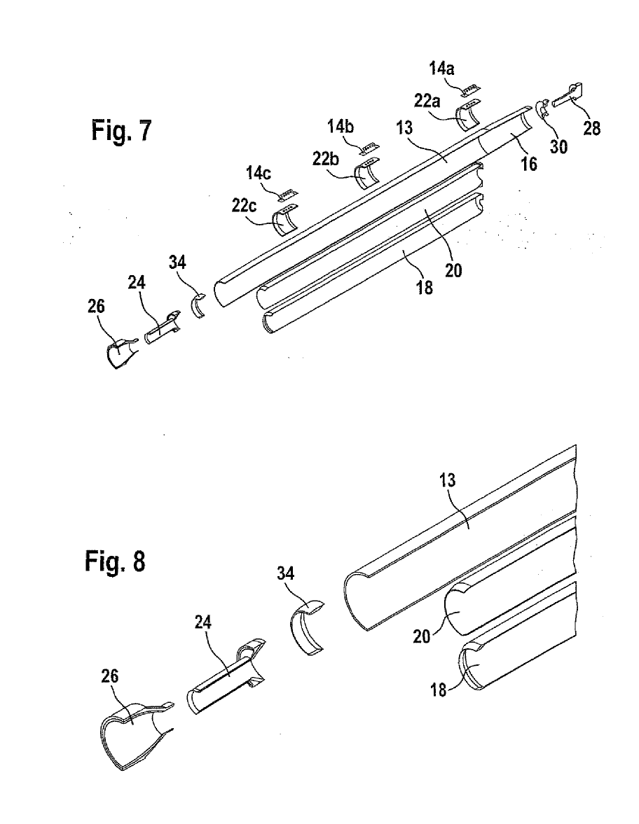

In the exemplary embodiment which is illustrated, inter alia, in FIG. 4, the combustion chamber 20 is held in a frame 22c, which is disposed between the outer casing 13 and the combustion chamber 20. In this case, it is held by the frame at least partially surrounding the combustion chamber in a substantially form-locking manner, although the form-locking connection has a dimensional tolerance, as a result of which a certain amount of freedom of movement remains for the combustion chamber 20 in the frame 22c. This makes it easier to fit and remove the combustion chamber 20, since both the outer casing 13 and the combustion chamber 20 are subject to discrepancies from an ideal shape, for example a tubular shape. Such discrepancies may be present, in particular, when the outer casing 13 has already been used. Instead of allowing residual movement of the combustion chamber 20 in one or more frames 22a, 22b, 22c, it is also possible to lock the combustion chamber 20 in one or more of these frames 22a, 22b, 22c by clamping. At this point, reference is made to the exploded illustration of FIG. 7 to show the position of the further frames 22a, 22b.

If the frames 22a, 22b, 22c are disposed suitably within the outer casing 13, they can additionally be used to increase the stiffness and robustness of the outer casing, in particular at those points where fittings or other attachments are provided. For this reason, in the present first exemplary embodiment, the frames 22a, 22b, 22c are disposed in the area of the holding lugs and, furthermore are each respectively connected to a holding lug 14a, 14b, 14c. By way of example, this connection may be ensured by a screw connection. As can be seen in FIG. 4, the holding lug 14c rests directly on the outer envelope or casing surface 12 of the outer casing 13. The outer casing 13 is clamped between the frame 22c and the holding lug 14c, which is connected thereto. This also applies to the holding lugs 14a and 14b as well as the frames 22a, 22b (see FIG. 7). The outer casing 13 is attached to the combustion chamber by the described clamping. Alternatively or additionally, it is possible to connect the outer casing 13 directly to one or more of the frames 22a, 22b, 22c, for example by a screw connection.

Load introduction points which are relevant for the attachment of the motor 10 to an aircraft, for example, are connected to the frames 22a, 22b, 22c by the described connection of the holding lugs 14a, 14b, 14c to the frames 22a, 22b, 22c and the clamping or other form of attachment of the outer casing 13 to the frames. In this case, these frames 22a, 22b, 22c are elements that provide robustness in a similar manner to the thickened areas 7 in the prior art (see FIG. 1). In contrast thereto, however, the reinforcements are disposed in the interior of the motor 10 and therefore have no adverse effect on the aerodynamics of the motor 10.

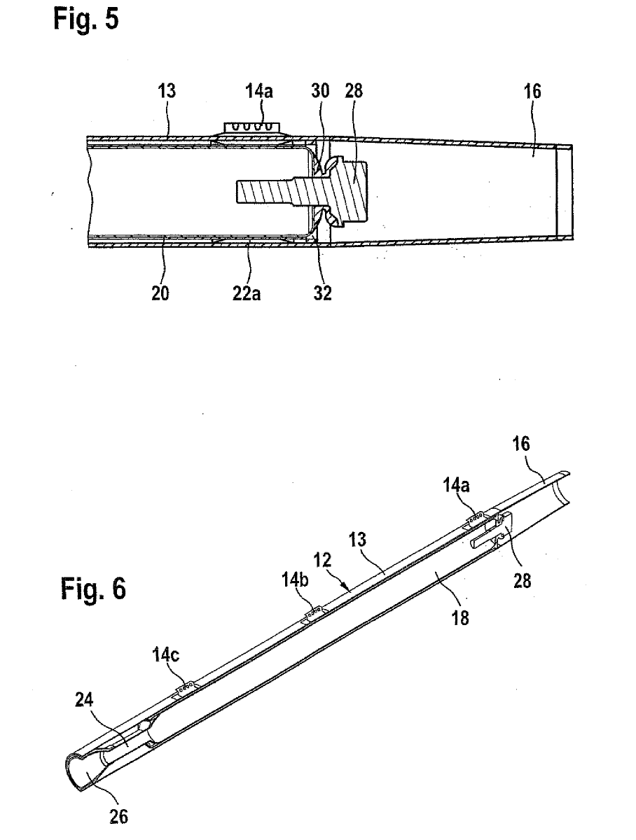

FIG. 5 shows an enlarged illustration of part of the right-hand end of the illustration shown in FIG. 3. In addition to the holding lug 14a which has already been mentioned and the frame 22a which has been mentioned, and which are each constructed in the same way as the described holding lug 14c and the frame 22c which has been mentioned, respectively, a skirt 32 can be seen in this figure, which is used to prevent the combustion chamber 20 from moving with respect to the outer casing 13. Furthermore, an igniter 28 can be seen, which extends into the combustion chamber 20 and is used to ignite the solid propellant which is disposed in the combustion chamber 20. In this case, the igniter 28 is attached to the combustion chamber 20 through the use of a pole cap 30.

In the exemplary embodiment illustrated in FIG. 5, the warhead 16 is conical, thus resulting in a sudden streamlined caliber change at its right-hand end, where a guidance device with a reduced diameter is normally disposed. FIG. 6 shows the sectional view of FIG. 3 once again, in the form of a perspective illustration, in which the opening at the right-hand end of the warhead 16 can be seen, where the described guidance part, for example, can be disposed.

FIG. 7 is an exploded illustration of the sectional view of FIG. 3, illustrating the individual components. As can be seen from this figure, the combustion chamber 20 is virtually completely clad with the thermal insulation 18. The left-hand end and right-hand end of the illustration in FIG. 7 are once again respectively shown in the form of enlarged, fragmentary illustrations in FIG. 8 and FIG. 9.

Since, in the exemplary embodiment shown in FIGS. 2 to 9, the pressure forces are absorbed by the combustion chamber 20, overpressure or mounting openings can be provided in the outer casing 13 without any adverse effect on the tamping of a solid propellant. By way of example, FIG. 9 shows a cable outlet opening 36, which is first of all used to pass a cable, which is disposed between the combustion chamber 20 and the outer casing 13, to the outer envelope or casing surface 12 of the outer casing 13, and to be connected there, for example, to a sensor. At the same time, the cable outlet opening 36 is used as an overpressure opening in order to ensure that a resultant overpressure in the event of inadvertent ignition of a solid propellant in the combustion chamber 20 can escape through the outer casing 13, before it explodes. This becomes effective only if the combustion chamber 20 has not previously been detonated. For this reason, in the present exemplary embodiment, the combustion chamber is manufactured from an unstable fiber composite material, which, as already described above, becomes mechanically unstable before reaching the ignition temperature of the solid propellant which is disposed in the combustion chamber and the insulation 18, as a result of which a pressure which is created after ignition of the solid propellant can escape through the unstable combustion chamber 20 and, inter alia, also escape through the outer casing through the overpressure opening which is formed by the cable outlet opening 36.

FIG. 10 shows a second exemplary embodiment of a solid-propellant motor according to the invention, in the form of a fragmentary, diagrammatic sectional view. In this figure, the outer casing 13 is not itself constructed to be high-temperature resistant, but is provided with a temperature protection layer 38 on its outer envelope or casing surface 12. By way of example, this layer could be formed by a heat-resistant ceramic. Furthermore, FIG. 10 illustrates a cable 40 which is disposed in the cavity 19 formed between the outer casing 13 and the combustion chamber 20, as well as a combined data receiving and transmitting device 42, which is disposed in this cavity 19. The diagrammatic illustration in FIG. 10 furthermore shows a frame 46 which has a cutout 48 through which the cable 40 is passed.

1. A solid-propellant motor, comprising:
an outer casing; and
a combustion chamber disposed within said outer casing, said combustion chamber being a separate component, separate from said outer casing.

2. The solid-propellant motor according to claim 1, wherein said outer casing is constructed to absorb inertia forces and inertia moments occurring during operation of the motor, and said combustion chamber is constructed to absorb pressures occurring during operation in said combustion chamber.

3. The solid-propellant motor according to claim 1, wherein said combustion chamber is disposed at a distance from said outer casing.

4. The solid-propellant motor according to claim 3, which further comprises at least one element selected from the group consisting of cables, cable harnesses, data transmitting devices, data receiving devices, antennas and plug connectors disposed between said combustion chamber and said outer casing.

5. The solid-propellant motor according to claim 1, which further comprises at least one frame disposed between said outer casing and said combustion chamber, said combustion chamber being held in said at least one frame.

6. The solid-propellant motor according to claim 5, wherein said at least one frame has cutouts for cables to pass through.

7. The solid-propellant motor according to claim 5, wherein said combustion chamber is form-lockingly held in said at least one frame.

8. The solid-propellant motor according to claim 5, wherein said combustion chamber is held with dimensional tolerances in said at least one frame.

9. The solid-propellant motor according to claim 5, which further comprises a holding lug resting indirectly or directly on an outer casing surface of said outer casing, said at least one frame being connected to said holding lug.

10. The solid-propellant motor according to claim 9, wherein said outer casing is clamped between said at least one frame and said holding lug connected to said at least one frame.

11. The solid-propellant motor according to claim 5, wherein said outer casing is connected to said at least one frame.

12. The solid-propellant motor according to claim 1, which further comprises at least one skirt securing said combustion chamber against movement relative to said outer casing.

13. The solid-propellant motor according to claim 1, wherein said outer casing is manufactured from a high-temperature-resistant material.

14. The solid-propellant motor according to claim 13, wherein said high-temperature-resistant material is a fiber composite material with a high-temperature matrix.

15. The solid-propellant motor according to claim 1, which further comprises thermal insulation disposed within said combustion chamber, said thermal insulation cladding said combustion chamber for thermal insulation from said combustion chamber of a solid propellant to be disposed in said combustion chamber.

16. The solid-propellant motor according to claim 1, wherein said thermal insulation substantially completely clads said combustion chamber.

17. The solid-propellant motor according to claim 1, wherein said combustion chamber is manufactured from a material being unstable above a limit temperature, and said limit temperature is less than or equal to an ignition temperature of a solid propellant to be disposed in said combustion chamber.

18. The solid-propellant motor according to claim 17, wherein said material is a fiber composite material.

19. The solid-propellant motor according to claim 1, wherein said outer casing has overpressure openings.

20. The solid-propellant motor according to claim 19, wherein said overpressure openings are mounting openings.

21. The solid-propellant motor according to claim 1, wherein said combustion chamber is a modular component.
